(19) United States
(12) Patent Application Publication
(10) Pub. No.: US 2026/0022053 A1
(43) Pub. Date: Jan. 22, 2026

(54) METHOD FOR PROCESSING HOLLOW CORE OPTICAL FIBRES

(71) Applicant: University of Southampton, Southampton (GB)

(72) Inventors: Natalie WHEELER, Southampton (GB); Peter HORAK, Southampton (GB); Radan SLAVIK, Southampton (GB)

(73) Assignee: University of Southampton, Southampton (GB)

(21) Appl. No.: 18/776,905

(22) Filed: Jul. 18, 2024

(51) Int. Cl. C03B 37/10; G02B 6/02; G02B 6/032

(52) U.S. Cl. CPC C03B 37/10; G02B 6/02328; G02B 6/032; C03B 2203/16

(57) ABSTRACT

A method for processing a hollow core optical fibre fabricated from a material includes: placing the central portion of the optical fibre into the interior of a pressure vessel; arranging end portions of the optical fibre outside of the pressure vessel; adding a purge gas to the interior of the pressure vessel, the purge gas being capable of permeating the material, the purge gas having a pressure greater than a partial pressure of the purge gas species within an initial gas content of the cladding and the hollow core; during a purge time, allowing the purge gas to permeate into the optical fibre to enter the cladding and the hollow core and push the initial gas content out of the cladding and the hollow core; and ending the purge time when a fraction of the initial gas content falls below a predefined threshold.

### BACKGROUND OF INVENTION

The present invention relates to a method for processing hollow core optical fibres.

Hollow core optical fibres are an alternative to conventional solid core optical fibres. A hollow core optical fibre is a fibre in which light is guided along a longitudinal hollow void forming the core of the fibre by an optical guidance mechanism enabled by the presence of a structured arrangement of longitudinal voids or capillaries forming a microstructured cladding surrounding the core void. The voids extend along the full length of the fibre, which can be very long; routine manufacturing currently produces lengths of fibre of the order of 10 km, but this is expected to increase to lengths of at least 100 km. In contrast, the holes or voids of the core and cladding have diameters on the micrometre scale, typically ranging from a few micrometres to around 150 μm, depending on the design of the fibre and the intended operating light wavelength. Various configurations for the cladding are known, producing different guidance effects. The absence of a solid glass core offers various benefits including low optical propagation loss, low latency and higher optical power handling (enabled by the absence of nonlinear optical effects that arise for light propagating in glass). The hollow core may be filled with gas (typically air) or a vacuum.

For many applications, an ability to control or modify the composition and pressure of gas in the hollow core and cladding is advantageous or essential. Typically, this involves altering a gas content within the fibre that arises inherently from fabrication of the fibre, possibly with additional ingress into the fibre from the gas of the surrounding environment after fabrication is the fibre ends are left open/unsealed. Current methods rely on purging or evacuating the fibre from one (or both) ends. A purging arrangement loads a purge gas into one end of the fibre at a higher pressure than the pressure at the other end of the fibre to create a pressure differential that drive gas flow along the fibre to push unwanted gas species from the fibre interior via the lower pressure end. However, the typical dimensions noted above give a very extreme aspect ratio between the hole diameters and the fibre length, which means that gas movement along the fibre takes a very long time. Gas filling and purge times scale with the square of the fibre length and with the inverse square of the hole diameters, from which it can be appreciated that purging time scales escalate dramatically for long fibre lengths and small hole diameters. The process can take many weeks, months or even over a year for long fibres. Similar problems arise when evacuating gas from inside a hollow core fibre via one or both ends. Currently, purging is achieved using typically an inert gas such as argon, loaded into the fibre from one end, and is limited to fibre lengths generally less than around a few hundred metres before the timescale becomes unattractively excessive.

Accordingly, improved methods of processing hollow core optical fibres to alter the interior gas content are of interest. Methods that can achieve purging or evacuation on shorter timescales are particularly desirable, in order to increase efficiency.

### SUMMARY OF THE INVENTION

Aspects and embodiments are set out in the appended claims.

According to a first aspect of certain embodiments described herein, there is provided a method for processing a hollow core optical fibre fabricated from a material, having a side wall surrounding a cladding and a hollow core, and having a central portion and two end portions, the method comprising: placing the central portion of the optical fibre into the interior of a pressure vessel; arranging both end portions of the optical fibre outside of the pressure vessel via pressure sealed apertures; adding a purge gas to the interior of the pressure vessel, the purge gas being a gas species capable of permeating through the material, wherein the purge gas has a purge gas pressure greater than a partial pressure of the purge gas species within an initial gas content of the cladding and the hollow core of the optical fibre; during a purge time, allowing the purge gas at the purge gas pressure to permeate into the optical fibre through a side wall of the central portion of the fibre to enter the cladding and the hollow core and push the initial gas content towards ends of the optical fibre and out of the cladding and the hollow core via the ends; and ending the purge time when a fraction of the initial gas content in the cladding and the hollow core falls below a predefined threshold.

These and further aspects of certain embodiments are set out in the appended independent and dependent claims. It will be appreciated that features of the dependent claims may be combined with each other and features of the independent claims in combinations other than those explicitly set out in the claims. Furthermore, the approach described herein is not restricted to specific embodiments such as set out below, but includes and contemplates any appropriate combinations of features presented herein. For example, methods may be provided in accordance with approaches described herein which includes any one or more of the various features described below as appropriate.

### BRIEF DESCRIPTION OF THE DRAWINGS

For a better understanding of the invention and to show how the same may be carried into effect reference is now made by way of example to the accompanying drawings in which:

FIGS. 1, 2 and 3 show schematic transverse cross-sectional views of antiresonant hollow core optical fibres to which methods disclosed herein can be applied, including cladding features from known fibre designs;

FIG. 4 shows a schematic and not-to-scale side view of an example hollow core optical fibre with indications of features relevant for the present disclosure;

FIG. 5 shows a flow chart of steps in an example method for processing a hollow core optical fibre according to the present disclosure;

FIG. 6 shows a simplified schematic view of an example apparatus suitable for carrying out a method according to the present disclosure;

FIG. 7 shows a graph obtained by modelling, of the partial pressure of a helium purge gas inside a hollow core fibre along the length of the fibre over time, during purging according to a method of the present disclosure;

FIG. 8 shows a graph obtained by modelling of the partial pressure of nitrogen inside the hollow core fibre along the length of the fibre over time, during the purging modelled in FIG. 7;

FIG. 9 shows a graph obtained by modelling of the time to reduce an original nitrogen content inside hollow core optical fibres to 1% as a function of fibre length, for a method in accordance with the present disclosure and two known methods;

FIG. 10 shows a graph of experimentally measured Raman spectra of a nitrogen proportion in a hollow core optical fibre, at different times during purging according to a method of the present disclosure; and

FIG. 11 shows a graph of experimentally measured and modelled nitrogen amounts inside hollow core optical fibres as a function of time during purging according to a method in accordance with the present disclosure, for a selection of different fibre lengths.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features methods discussed herein which are not described in detail may be implemented in accordance with any conventional techniques for implementing such aspects and features.

Hollow core fibres can be categorised according to their mechanism of optical guidance into two principal classes or types: hollow core photonic bandgap fibre (HCPBF, alternatively often referred to as hollow core photonic crystal fibres, HCPCF) [1], and antiresonant hollow core fibre (AR-HCF or ARF) [2]. There are various subcategories of ARFs characterised by their geometric structure, including kagome fibres [3, 4], nested antiresonant nodeless fibres (NANFs) [5] and tubular fibres [6]. The present disclosure is applicable to all types of hollow core fibre, including these two main classes and their associated sub-types plus other hollow core designs. Note that in the art, there is some overlapping use of terminologies for the various classes of fibre. For the purposes of the present disclosure, the term “hollow core fibre” is intended to cover all types of these fibres having a hollow core as described above. The terms “HCPBF” and “HCPCF” are used to refer to hollow core fibres which have a structure that provides waveguiding by photonic bandgap effects (described in more detail below). The terms “ARF” and “antiresonant hollow core fibre” are used to refer to hollow core fibres which have a structure that provides waveguiding by antiresonant effects (also described in more detail below).

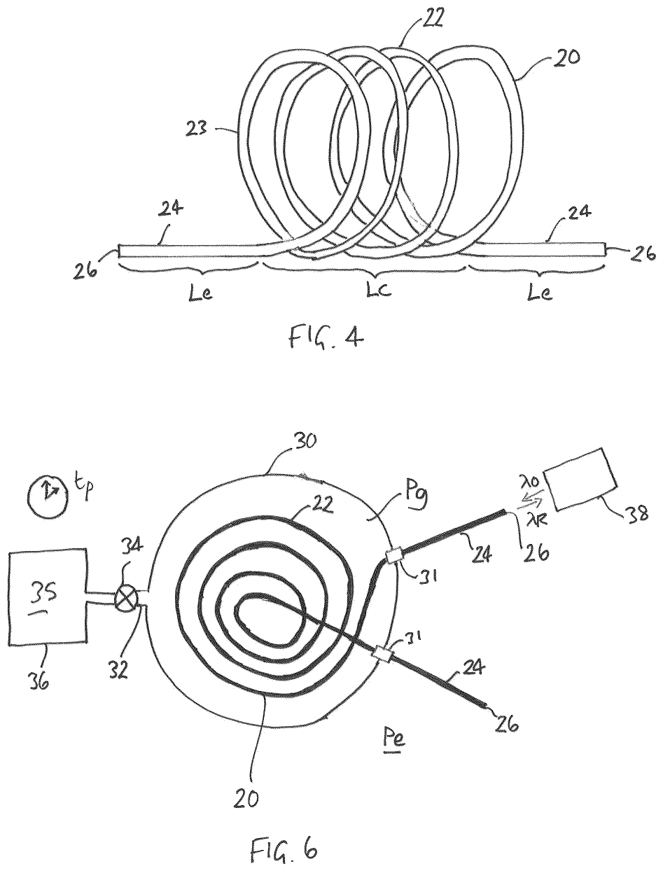

FIG. 1 shows a transverse cross-sectional view of an example HCPBF 10. In this fibre type, the structured, inner, cladding 1 comprises a regular closely packed array of many small glass capillaries, from which a central group is excluded to define a substantially circular hollow core 2. The periodicity of the cladding structure provides a periodically structured refractive index and hence a photonic bandgap effect that confines the propagating optical wave towards the core. These fibres can be described in terms of the number of cladding capillaries or “cells” which are excluded to make the core 2. In the FIG. 3 example, the central nineteen cells from the array are absent in the core region, making this a 19-cell core HCPBF. The structured cladding 1 is formed from six rings of cells surrounding the core 2, plus some cells in a seventh ring to improve the circularity of the outer surface of the cladding. An outer cladding or outer jacket 3 surrounds the structured cladding 1.

In contrast to HCPBF, antiresonant hollow core fibres guide light by an antiresonant optical guidance effect. The structured cladding of ARFs has a simpler configuration, comprising a much lower number of larger glass capillaries or tubes than a HCPBF to give a structure lacking any high degree of periodicity so that photonic bandgap effects are not significant. Rather, antiresonance is provided for propagating wavelengths which are not resonant with a wall thickness of the cladding capillaries, in other words, for wavelengths in an antiresonance window which is defined by the cladding capillary wall thickness. The cladding capillaries surround a central void or cavity which provides the hollow core of the fibre, and which is able to support antiresonantly-guided optical modes. The structured cladding can also support cladding modes able to propagate primarily inside the capillaries, in the glass of the capillary walls or in the spaces or interstices between the cladding capillaries and the fibre's outer cladding. The loss of these additional non-core guided modes is generally very much higher than that of the core guided modes. The fundamental core guided mode typically has by far the lowest loss amongst the core guided modes. The antiresonance provided by a capillary wall thickness which is in antiresonance with the wavelength of the propagating light acts to inhibit coupling between the fundamental core mode and any cladding modes, so that light is confined to the core and can propagate at very low loss.

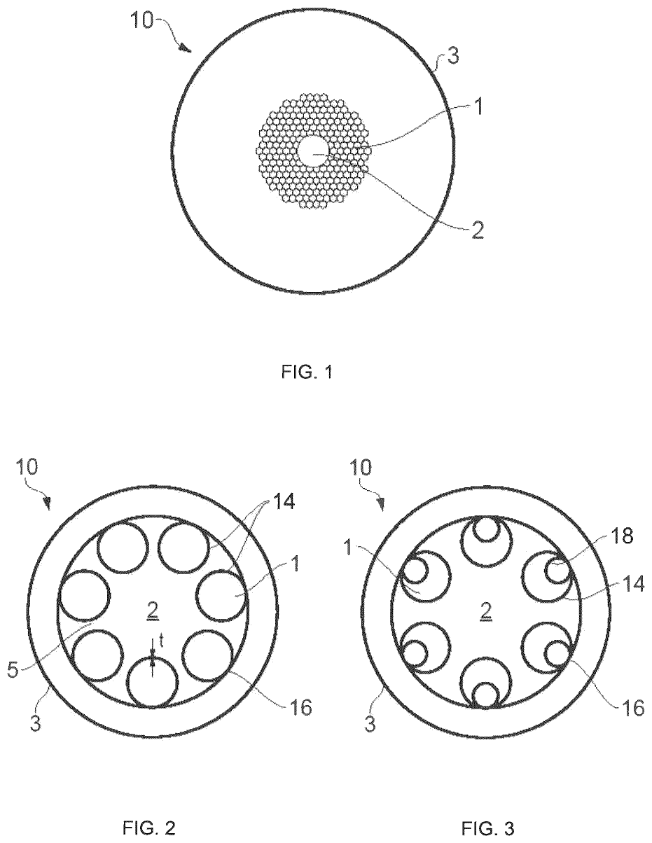

FIG. 2 shows a transverse cross-sectional view of an example simple antiresonant hollow core fibre. The fibre 10 has an outer tubular cladding or outer jacket 3. The structured, inner, cladding 1 comprises a plurality of tubular cladding capillaries 14, in this example seven capillaries of the same cross-sectional size and shape, which are arranged inside the outer cladding 3 in a ring, so that the longitudinal axes of each cladding capillary 14 and of the outer cladding 3 are substantially parallel. Each cladding capillary 14 is in contact with (bonded to) the inner surface of the outer cladding 3 at a location 16, such that the cladding capillaries 14 are evenly spaced around the inner circumference of the outer cladding 3, and are also spaced apart from each other by gaps s (there is no contact between neighbouring capillaries). In some designs of ARF, the cladding tubes 14 may be positioned in contact with each other (in other words, not spaced apart as in FIG. 4), but spacing to eliminate this contact can improve the fibre's optical performance. The spacing 5 removes nodes that arise at the contact points between adjacent tubes and which tend to cause undesirable resonances that result in high losses. Accordingly, fibres with spaced-apart cladding capillaries may be referred to as “nodeless antiresonant hollow core fibres”.

The arrangement of the cladding capillaries 14 in a ring around the inside of the tubular outer cladding 3 creates a central space, cavity or void within the fibre 10, also with its longitudinal axis parallel to those of the outer cladding 3 and the capillaries 14, which is the fibre's hollow core 2. The core 2 is bounded by the inwardly facing parts of the outer surfaces of the cladding capillaries 14. This is the core boundary, and the material (glass or polymer, for example) of the capillary walls that make up this boundary provides the required antiresonance optical guidance effect or mechanism. The capillaries 14 have a thickness t at the core boundary which defines the wavelength for which antiresonant optical guiding occurs in the ARF. FIG. 2 shows merely one example of an ARF. Many other possible ARF structures are known.

FIG. 3 shows a transverse cross-sectional view of a second example ARF. The ARF has a structured inner cladding 1 comprising six cladding capillaries 14 evenly spaced apart around the inner surface of a tubular outer cladding 3 and surrounding a hollow core 2. Each cladding capillary 14 has a secondary, smaller capillary 18 nested inside it, bonded to the inner surface of the cladding capillary 14, in this example at the same azimuthal location 16 as the point of bonding between the primary capillary 14 and the outer cladding 3. These additional smaller capillaries 18 can reduce the optical loss. Additional still smaller tertiary capillaries may be nested inside the secondary capillaries 18. ARF designs of this type, with secondary and optionally smaller further capillaries, may be referred to as “nested antiresonant nodeless fibres”, or NANFs [5].

Many other capillary configurations for the structured cladding of an ARF are possible, and the disclosure is not limited to the examples described above. For example, the capillaries need not be of circular cross-section, and/or may or may not be all of the same size and/or shape. The number of capillaries surrounding the core may be for example, four, five, six, seven, eight, nine or ten, although other numbers are not excluded.

The ring of cladding capillaries in an ARF creates a core boundary which has a shape comprising a series of adjacent inwardly curving surfaces (that is, convex from the point of view of the core). This contrasts with the usual outward curvature of the core-cladding interface in a conventional solid core fibre, and the substantially circular core boundary of a HCPBF (see FIG. 1). Accordingly, antiresonant hollow core fibres can be described as negative curvature fibres. The kagome category of ARF can also be configured as negative curvature fibres, and has a structured cladding of multiple small capillaries in an array, similar to HCPBF, but not configured to provide photonic bandgaps. In contrast to HCPBF, the guidance mechanism operates by antiresonance effects.

Herein, the terms hollow core optical fibre, hollow core fibre, hollow core waveguide, hollow core optical waveguide and similar terms are intended to cover optical waveguiding structures configured according to any of the above examples and similar structures, where light is guided by any of several guidance mechanisms (photonic bandgap guiding, antiresonance guiding, and/or inhibited coupling guiding) in a hollow elongate void or core surrounded by a structured cladding comprising a plurality of longitudinal capillaries. The capillaries comprise or define elongate holes, voids, lumina, cells or cavities which run continuously along the length or longitudinal extent of the optical fibre, substantially parallel to the elongate core which also extends continuously along the fibre's length. These various terms may be used interchangeably in the present disclosure.

Methods described herein are applicable to all designs and configurations of hollow core optical fibres, regardless of internal structure and waveguiding mechanism. The methods relate to the gas content of hollow core fibres, and are independent of the optical properties of the fibres and the structural features that produce these properties, beyond the presence of a hollow core.

Hollow core fibres are fabricated similarly to solid core optical fibres, in that a relatively short preform or a cane, having a cross-sectional structure comprising elements corresponding to the required elements in the finished fibre (core, cladding, outer jacket layers) but on a much larger scale, is heated in a furnace and pulled or drawn down into a much smaller diameter and much longer length in drawing tower. An additional feature of drawing for hollow core fibres is the application of one or more pressures or a vacuum to the various voids in the preform during the draw to produce desired relative sizes of the core and cladding voids and prevent or cause collapse of particular voids.

It is known that immediately post-fabrication, gas pressure in the core and cladding of a hollow core fibre is low, typically significantly sub-atmospheric such as around 25,000 Pa (0.25 bar). The gas composition within the fibre, in the core and cladding voids, generally can include nitrogen, carbon dioxide and oxygen (from air), hydrogen chloride (linked to the presence of chlorine in the glass from which optical fibres are commonly fabricated), and other gas species used or generated in the fabrication process. If the ends of such a fibre are left open after fabrication, gas from the surrounding environment (usually atmospheric air) will ingress into the fibre through its ends, driven by the pressure difference between the surroundings environment and the lower pressure inside the fibre. The result is that, most commonly, the core and cladding of a hollow core optical fibre are filled with air, plus low levels of other gases such as hydrogen chloride and water vapour. These gas species have a plethora of optical absorption lines which occur over different wavelength ranges according to the gas species. Absorption of propagating light due to the presence of these gases limits the usable optical bandwidth of the fibre, and is therefore undesirable. The gases are therefore unwanted and can be considered as contaminants. This issue is particularly relevant for long distance optical applications such as telecommunications, when the cumulative effect of even trace levels of contamination can lead to significant absorption of propagating light. Furthermore, certain gas species can have other negative impacts for optical and mechanical performance of the fibre, thereby affecting long-term reliability of hollow core fibres. For example, hydrogen chloride is a key ingredient in unwanted ammonium chloride formation on the end facets of hollow core fibres, which over time can significantly reduce the efficiency of optical coupling into the fibre. Hence, the removal of unwanted gases from the interior of hollow core optical fibres, by purging to replace the gases with more neutral or desirable species, or evacuating to create a vacuum or reduced pressure, is an important process. More generally, this can be described as controlling the gas composition and/or pressure within hollow core optical fibres.

Current purge methods generally access one end of the fibre for the loading of a purge gas at increased pressure, and rely on a pressure differential between the ends of the fibre to drive gas flow along the voids through the length of the fibre. Current evacuation methods implement a reduced pressure (for example using a vacuum pump) at one or both ends of the fibre to remove gas content from the voids within the fibre. The extreme aspect ratio of the fibre structure arising from very narrow void diameters compared with the very long length of the fibre means that the required movement of gas takes a very long time, extending to weeks or months through to over a year as fibre length increases. This is clearly inefficient, and very impractical or unworkable for long fibre lengths.

To address this, a new approach for controlling gas content in hollow core optical fibres is proposed herein. This may be to, for example, remove a gas content arising directly from fabrication of the hollow core fibre, as noted above, or to replace the gas content with a particular desired gas species, or to achieve a particular internal gas pressure in the core and cladding, including a vacuum, or to correct an existing gas content, or to restore a previous gas content. For convenience and brevity, the term “gas content” as used herein is intended to include either or both of the gas composition (species/type of gas and relative proportions of the gas or gases) and the gas pressure within the core and cladding of a hollow core fibre. In some instances, gas composition or gas pressure will be specifically referred to, where appropriate, however.

The new method proposes the use of permeation or diffusion of a purge gas through the side wall of a hollow optical fibre and into the cladding and core voids, in contrast with known approaches of feeding a purge gas (or evacuating the existing gas content) into the fibre through an end. The permeation is driven by arranging the purge gas to be at a higher pressure than the partial pressure of the purge gas comprised in the gas content in the fibre, so that a pressure difference is provided to create an inward flow of the purge gas from the exterior of the fibre, through the side wall and into the interior. Once inside the fibre, the influx of the purge gas leads to an increase in the total gas pressure within the fibre, which forces the existing gas within the core and cladding towards the fibre ends and out of the fibre, so that the gas content is reconfigured to comprise the purge gas at a high proportion. The expression “purge gas comprised in the gas content of the fibre” should be understood to mean “gas of the same species as the purge gas which is comprised in the gas content of the fibre”, which will generally become present from permeation through the side wall so that the relevant gas inside the fibre originated as purge gas outside the fibre, but may include gas of the same species comprised in the initial gas content. Typically, the purge gas will be of a different gas species from the initial gas content so that before application of the pressurised purge gas the partial pressure of the purge gas species within the fibre will be zero, and then increasing as the purge gas permeates through the side wall. Delivery of the purge gas through the side wall enables a much larger access area compared to the small cross-sectional area of voids at an end of the fibre, so a much larger volume of purge gas can be introduced into the fibre in a much shorter amount of time.

The materials from which hollow core optical fibres are made, often glass or sometimes a polymer, are permeable to certain gases, so the proposed method can be implemented by selection of a suitable gas. Choice of gas is discussed further below.

An example of gas permeation through a hollow core optical fibre wall uses helium as buffer gas in the fabrication of hollow core fibre gas cells [7, 8]. A hollow core fibre is evacuated from one or both ends (via bulk gas chambers and using a suitable vacuum pump) and then backfilled (again from one or both fibre ends) with a gas of interest for metrology applications (such as acetylene). The fibre is then evacuated again (using a pump) to reduce the acetylene pressure to significantly below atmospheric (necessary for metrology applications). Then the fibre is filled with helium at around 200 Pa from one or both ends and subsequently removed from the bulk chambers and vacuum pump system. The fibre is then spliced quickly (less than one minute per splice) at both ends to standard all-solid optical fibre; this hermetically seals the gas within the core and cladding, which at this point is mainly helium, with a trace level of acetylene. The helium is present to inhibit air ingress during the splicing process, since acetylene is the gas content of interest. After splicing, the helium then permeates out through the fibre wall into the surrounding environment, leaving behind low pressure acetylene only. Note that the helium, used only to prevent air ingress during splicing, permeates outwardly through the fibre wall, from the interior to the external environment. This is in contrast with the presently proposed concept, which uses gas permeation in the opposite direction, through the fibre side wall from the external environment into the fibre interior, the gas being used for purging to push existing gas out of the fibre via its ends.

FIG. 4 shows a highly schematic and not to scale depiction of an example hollow core optical fibre to which methods described herein may be applied, for the purpose of showing parts of the optical fibre relevant for the methods. The optical fibre 20 is a hollow core optical fibre according to any of the various examples and variants described above. The optical fibre 20 therefore has a central hollow core void (not shown) surrounded by a microstructured cladding comprising multiple voids (not shown). Around the cladding the optical fibre 20 has an outer jacket that provides a side wall 23 for the optical fibre 20. Typical thicknesses for the side wall/outer jacket of a hollow core optical fibre are in the range of about 30 μm to 250 μm, but wall thickness values outside this range (thinner or thicker) are not excluded from the present disclosure. The outer jacket and the capillaries forming the cladding structure are made from a suitable material for hollow core optical fibres. The majority of hollow core optical fibres are fabricated from glass, in other words, a silica material. Commonly, this is synthetic silica specifically formulated to have a very high purity level, but other silicas may be used. Since in a hollow core optical fibre the light does not propagate in glass, the optical properties of the glass are less relevant than for solid core optical fibres, which may be made from glass comprising dopants to modify the optical properties. For hollow core waveguiding, however, a high purity (low level of contaminants or other trace materials) is more relevant, for example to ease fibre drawing. Hollow core optical fibres formed from polymer materials are also known. Methods of the present disclosure are applicable to both glass (for example silica, chalcogenide and fluoride glass materials) and polymer optical fibres, since the various proposed gases for purging can diffuse through glass and through those polymers which are suitable for hollow core optical fibre fabrication. Hollow core optical fibres can also include an outer protective layer (around the outer jacket), typically formed from polymer. It has been found that the presence of a protective layer has little if any effect on gas permeation through the side wall of the fibre so can be ignored and considered as part of the outer jacket, where the outer jacket thickness in part determines suitable parameters for the permeation process.

The optical fibre 20 has two ends 26 (being end facets of the optical fibre 20, which for the purpose of performing the proposed permeation process are not sealed; i.e. the core and cladding are not closed and are open and accessible through the fibre ends 26. Hence, core and cladding voids, i.e. the interior of the optical fibre 20, are in gas flow communication with the surrounding environment external to the fibre ends 26. The optical fibre has a total length L defined from one end 26 to the other end 26, and this total length can be notionally divided into three portions. Hence, the optical fibre 20 comprises a central portion 22 comprising the majority of the length of optical fibre 20, lying between two end portions 24. Each end portion 24 extends between an edge of the central portion 22 and an end 26 of the optical fibre 20. The central portion 22 has a length Lc and the end portions 24 each have a length Le. For convenience we can consider the two end portions 24 to have the same length Le, but this is not essential. As a generalisation, typically Lc >>Le. This is discussed in more detail later.

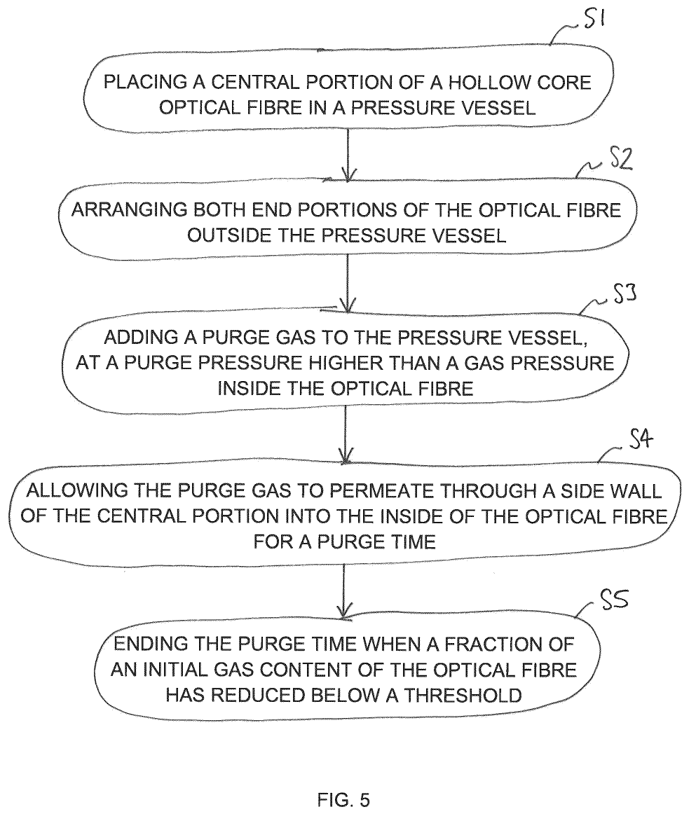

FIG. 5 shows a flow chart of an example method of processing a hollow core optical fibre (such as the FIG. 4 example) according to the currently proposed method. In a first step S1, the central portion of the optical fibre is placed inside a pressure vessel. By this is meant a vessel that can be pressure sealed against the external environment, and the pressure of the interior of the vessel increased by filling the vessel with a pressurised gas. In a second step S2, both of the end portions of the optical fibre are arranged so as to be outside the pressure vessel, via one or more pressure sealed apertures in a wall of the pressure vessel. This configuration means that the central portion of the optical fibre can be exposed to a pressurised gas, while at the same time the open core and cladding exposed at the ends of the fibre are in gas flow communication with the external environment. Hence, the fibre interior can vent to the external environment, which is typically at atmospheric pressure. The fibre interior, comprising the cladding and the hollow core, contains an initial gas content (initial indicating the gas content at the start or initiation of the method), for example, the gas content arising from fabrication of the optical fibre. The interior pressure of the optical fibre, in other words the pressure of the initial gas content, may be below or considerably below atmospheric pressure, for example if the optical fibre has been recently fabricated. Older optical fibres or optical fibres with gas content which has been previously modified in some way may have an initial gas content pressure closer to, equal to, or above atmospheric pressure.

In a third step S3, a purge gas is added into the interior of the pressure vessel. The purge gas is selected to be a gas species which is capable of permeating through the material from which the optical fibre is fabricated. Examples of purge gases are given later. The purge gas has a purge gas pressure which is higher than the partial pressure of any gas of the purge gas species present in the initial gas content of the optical fibre. At this stage of the process this partial pressure will be zero when the selected purge gas species is different from the gas species making up the initial gas content, and none of the purge gas has yet permeated into the fibre. The purge gas pressure may be achieved in any convenient manner, such as adding the purge gas at atmospheric pressure and then increasing the pressure by adding further gas, or by flowing already-pressurised gas into the pressure vessel. The higher pressure of the purge gas compared to the partial pressure of that gas species inside the fibre creates a pressure differential or pressure gradient between the interior of the central portion of the optical fibre, and the surrounding environment which is the interior of the pressure vessel, filled with the pressurised purge gas. In a fourth step S4, the purge gas is allowed to permeate through the side wall of the central portion of the fibre. The pressure differential drives permeation or diffusion of the purge gas through the material of the side wall of the optical fibre, so that the core and cladding of the central portion start to fill with the purge gas. This enhances the total gas pressure inside the optical fibre and forms a pressure differential between the central part of the fibre and its open ends; thus the purge gas displaces the initial gas content, and pushes the initial gas content along the core and the cladding towards and through the end portions of the optical fibre. The initial gas content vents to the environment surrounding the pressure vessel through the open ends of the fibre and is hence removed from the optical fibre. The purge gas therefore gradually replaces the initial gas content within the optical fibre. Any unwanted gas species in the original gas content are thereby substantially removed. The permeation is continued for a purge time.

In a step S5, the purge time is ended. The purge gas pressure is removed, such as by venting or otherwise removing the purge gas from the interior of the pressure vessel, or returning the purge gas pressure within the pressure vessel to a lower pressure or atmospheric pressure. The pressure differential between the interior and the exterior of the central portion of the optical fibre is thereby removed, and permeation of the purge gas into the central portion ceases. This is done when the amount of the initial gas content of the optical fibre is adequately reduced, such as when the purge gas completely or near completely fills the core and cladding, and all or nearly all of the original gas content has exited the optical fibres via its ends. This can be considered to be a fraction of the initial gas content remaining inside the core and the cladding has fallen below a predefined threshold. Alternatively, this condition might be defined as being when the proportion of the current gas content of the optical fibre (now comprising mostly or completely the purge gas) which comprises the initial gas content has fallen below a predefined threshold. Depending on requirements, this might be set such that the fraction of the initial gas content remaining in the fibre is 10% or less, or 5% or less, or 1% or less, or 0.1% or less, for example (the percentage being a percentage of the original amount of the initial gas content before purging). The threshold might be selected to be in the range of 0.1% to 10% of the initial gas content, for example. Values above or below this range are not excluded however, and may be selected according to a gas composition within the optical fibre required for an intended purpose of the optical fibre.

In another variation, it may be desired to increase the pressure of the gas content in the fibre above the initial gas content pressure, rather than to eliminate the initial gas content. This might be useful to bring the internal pressure of a newly fabricated optical fibre, which as noted above tends to be below atmospheric pressure, up to atmospheric pressure, for example. Such pressure equalisation also inhibits debris and contaminants being drawn into the internal fibre structure through the fibre ends (or at a newly cut end if the fibre is divided into shorter lengths) via inward movement of air flow from the environment. Other pressure increases to pressures above atmospheric pressure can also be achieved if desired. Accordingly, the process may be operated to drive the purge gas into the core and cladding of the hollow core fibre via the pressure difference between the purge gas inside and outside the hollow core fibre, with the purge pressure being stopped once the pressure within the fibre reaches the desired value. The gas content in the fibre now comprises a mixture of the initial gas content species and the purge gas, with the fraction of the initial gas content being reduced from 100% to something above 0%. The predetermined threshold that ends the purge time corresponds to this fraction giving the desired pressure inside the fibre. The fibre ends may then be sealed to retain the new gas content, although this is optional.

The length of the purge time required to decrease the initial gas content below the threshold is dependent on a number of factors, and can be selected appropriately having regard to the operational parameters. A certain time will be necessary for movement of the purge gas through the material of the side wall of the optical fibre. This depends in part on the thickness of the wall; clearly the purge gas reaches the cladding and core regions of the fibre more quickly for a thinner wall than a thicker wall. The permeation speed through the material also varies for different combinations of optical fibre material and purge gas species. The size of the pressure differential also affects the purge time. A larger pressure differential can drive the purge gas through the side wall more quickly, and then also along the core and cladding towards the fibre ends more quickly. The total length of the optical fibre, and the ratio of the central portion, which receives the purge gas directly, to the length of the end portions, which received the purge gas only from flow of the purge gas along the core and cladding, are also relevant factors. Overall, a longer fibre will need a longer purge time, and a larger proportion of the fibre being comprised by the central portion can reduce the purge time. Also, the temperature of the purge gas and of the fibre material plays a part. A higher temperature of the fibre material increases the speed of the individual gas molecules of the purge gas, and drives the inward permeation movement more quickly. A raised temperature can be achieved by directly heating the optical fibre, or by heating the purge gas which will quickly thermalise the optical fibre, which may be a more convenient approach. Hence, an increased purge gas temperature and/or an increased optical fibre temperature can reduce the purge time (depending on purge gas, fibre length and/or fibre geometry). It will be appreciated from this that a number of factors contribute to give an overall permeation rate, which combines with the fibre length and desired level of purging (reduction in the amount of the initial gas content to below the specified threshold) to result in a relevant purge time for a given implementation of the method. The various factors are discussed further below.

Helium is able to permeate glass at room temperature, and this offers a further benefit since it enables the proposed purging method to be additionally used for evacuation of hollow core fibres via a simple additional processing stage. For some applications, a vacuum or near-vacuum is required in the core and cladding of a hollow core optical fibre. Currently, this is achieved by vacuum pumping the existing gas content out from the fibre interior via both ends of the fibre. After pumping, the ends are sealed to retain the internal vacuum.

The present process can be modified to achieve an evacuated hollow core optical fibre. In the case of a silica fibre which has been purged by side permeation of helium, the two ends of the optical fibre are sealed promptly after purging, when the core and cladding are filled with helium. This helium is at a raised pressure, from the purging process. Once removed from the purge gas pressure environment, a pressure differential therefore exists between the pressurised helium inside the optical fibre, and the partial pressure of any helium in the surrounding environment at atmospheric pressure. Hence, the helium is driven by this pressure gradient to permeate through the side wall of the fibre in the outward direction, so that it leaves the fibre. The sealed ends prevent the ingress of air to replace the departing helium, and a reduced pressure or vacuum results in the cladding and core.

While helium is useful to enable this additional processing stage owing to its room temperature permeation capability, the same process might be used with other purge gases if the optical fibre is heated after its ends have been sealed. Similarly, heating the fibre after the ends have been sealed when helium has been used as the purge gas will increase the rate of outward permeation, so that a reduced pressure or vacuum is achieved more quickly.

FIG. 6 shows a simplified highly schematic and not to scale representation of an example apparatus for carrying out the method of FIG. 5. A pressure vessel 30 is provided. A hollow core optical fibre 20 is placed in the pressure vessel 30 such that a central portion 22 of the optical fibre 20 is located in the interior of the pressure vessel 30, and the end portions 24 of the optical fibre 20 are located outside of the pressure vessel 30. The end portions exit the pressure vessel 30 via one or two suitable pressure sealed apertures 31 or fibre outlets in the wall of the pressure vessel 30. This places the open ends 26 of the optical fibre 20 in gas flow communication with the surrounding environment external to the pressure vessel, which is at an environmental pressure Pe (typically atmospheric pressure). A reservoir 36 of purge gas 35 is connected to the pressure vessel 30 via a gas inlet 32, controlled by a valve 34. The pressure vessel is sealed once the optical fibre 20 is installed for purging, and the valve 34 is opened to introduce purge gas 35 into the interior of the pressure vessel 30 to achieve the desired purge gas pressure Pg inside the pressure vessel, surrounding the central portion 22 of the optical fibre 20. The required pressure differential between the purge gas and the initial gas content of the optical fibre is thereby achieved, and permeation takes place. If the purge gas 35 is required to be heated, for example to raise its temperature above or significantly above room temperature, a heater arrangement (not shown) can be included. This might heat the purge gas 35 while it is in the reservoir 26, or may heat the purge gas 35 once it is inside the pressure vessel 30, for example.

If a required purge time appropriate for reaching the initial gas content fraction threshold is known already (for example from previous experimental or test purges), the purge can be timed and carried out for that known purge time tp, where the purge gas pressure is terminated when the duration of the purge time tp has elapsed. This may be useful for fibre processing in a commercial/industrial arrangement, for example, when purging of known fibre lengths under known conditions can be carried out repeatedly. Alternatively, the gas content within the optical fibre 30 may be monitored during the purge, and the time during which the purge is performed can be ended by removing the purge gas pressure when the monitoring indicates that the initial gas content fraction has fallen to or below the predetermined threshold.

Monitoring of the gas content can be performed optically, for example by observing an optical signal that carries information indicative of the gas content. Raman spectroscopy is suitable for this purpose. FIG. 6 shows a spectrometer 38, but this is not limiting, and other optical monitoring apparatus might be used. For Raman spectrometry, laser light at a suitable wavelength λ0 is launched into an end of the optical fibre, and undergoes Raman scattering from gas molecules in the core of the optical fibre. The scattering can be detected in forward and/or backward scattering directions; in this instance the scattering is detected in the back direction, so the scattered light propagates back along the fibre and exits the same fibre end where it is detected. Also, Raman scattering is shifted in frequency from the original light signal according to the molecules causing the scattering, so that different gas species have different signature backscattered Raman spectrums at wavelength AR, distinguishable from the launched light signal. Observation of the Raman spectrum for a gas species in the initial gas content over the purge time therefore shows a decreasing power level, as the initial gas content is gradually eliminated from the fibre interior and replaced by the purge gas. Accordingly, the strength of the backscattered Raman power directly indicates the fraction of remaining initial gas content, and it can be readily ascertained that this has fallen below the predetermined threshold so that the purge time can be stopped. As an example, if the optical fibre has an initial gas content which is at least partly air, the Raman spectrum for nitrogen can be monitored, since air is largely comprised of nitrogen, and a decreasing signal at the Raman-shifted wavelength for nitrogen shows the decrease in the proportion of air inside the fibre as it is displaced by the incoming purge gas. Input laser light at a wavelength of 532 nm can be used for detecting Raman shifted light from nitrogen, for example. Note that the nitrogen Raman signal will not be completely reduced to zero owing to a small amount of air able to diffuse into the fibre via the open end through which the monitoring is carried out (this is more dominant for shorter total fibre lengths since the amount of the end portion into which the in diffused air can penetrate represents a larger proportion of the total fibre length which is otherwise filled with purge gas), but this can be accounted for when assessing completion of the purge process. A steady state will be reached beyond which the nitrogen signal is not further reduced. In other examples, Raman backscattered from other gas species in the initial gas content might be monitored instead.

Modelling of a specific example of a method according to the disclosure will now be described. The optical fibre is formed from silica, and has a length of 500 m. For simplicity of modelling the optical fibre is modelled as a simple tube or capillary, corresponding to the outer jacket and the hollow core of a real hollow core optical fibre, with the microstructured cladding omitted. Since the wall thickness of the capillaries forming the cladding is much less than the outer jacket thickness in a real fibre, the cladding contributes only a small part to the total material through which the purge gas must permeate, so this provides a reasonable approximation. The modelled tube has a 200 μm outer diameter and a 40 μm inner diameter, corresponding in an actual hollow core optical fibre to a 40 μm diameter for the core plus the cladding and an 80 μm wall thickness for the outer jacket; these are typical hollow core fibre dimensions. To represent an initial gas content of air, the optical fibre is modelled as having an initial gas content comprising nitrogen at 100 kPa pressure (1 bar, or approximately atmospheric pressure). Helium is used as the purge gas. Helium is considered a particularly useful option for a purge gas for many hollow core optical fibres, because it permeates readily through silica at room temperature (approximated herein as 20° C.), with a relatively modest pressure differential giving a good permeation rate. In the modelling, the helium is at 2000 kPa (20 bar). Hence, there is a 1900 kPa (19 bar) pressure difference between the purge gas outside the fibre and the nitrogen gas inside the fibre, and the purge gas pressure is 20× the initial gas content pressure in the fibre. Before permeation begins, there is no helium inside the fibre, so the partial pressure of the purge gas species inside the fibre is zero. The ends of the optical fibre are open so that the core and cladding can vent to atmospheric pressure. The central portion of the optical fibre is set to be the whole fibre length of 500 m, so that the end portions have a zero length. This is possible in modelling; in reality at least a small non-zero end portion length will be necessary to allow for the ends of the fibre to reach through the wall of the pressure vessel to the exterior environment.

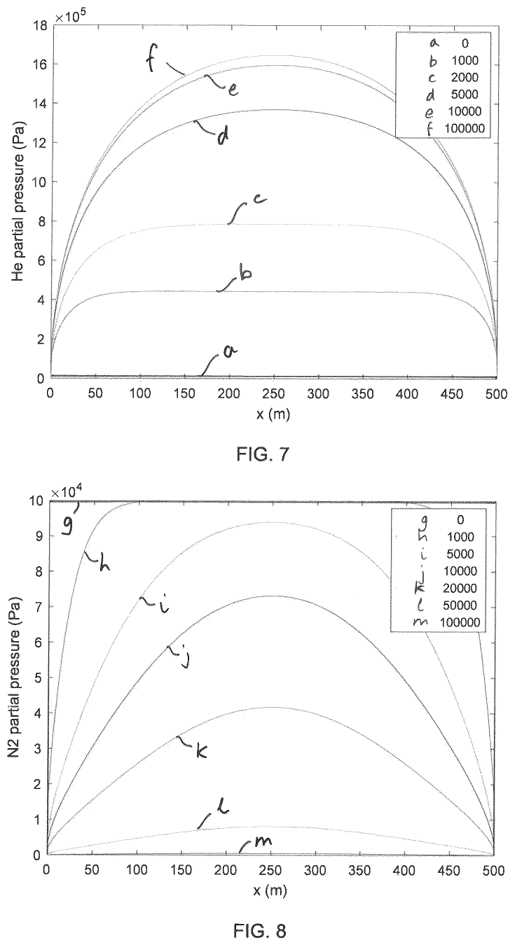

FIG. 7 shows a graph of the partial pressure of the helium purge gas inside the fibre (vertical axis) along the length of the fibre (horizontal axis), over time, obtained from the modelling. An initial time of about 7 minutes is allowed for the helium to permeate through the side wall of the fibre and into the hollow core, at which point time is designated as 0 seconds, for which line a on the graph shows the partial pressure also as zero along the whole fibre length (where partial pressure corresponds to the proportion of the gas content inside the fibre comprised by the helium purge gas). The partial pressure is shown at later times of 1000, 2000, 5000, 10000 and 100000 seconds, as lines b, c, d, e and f respectively. From this it can be seen that the amount of helium in the hollow core increases over time, as the nitrogen is displaced and pushed out of the open ends of the fibre. Little increase is seen between 10000 and 100000 seconds, showing that the purge process is reaching a steady state at which the hollow core is not able to accept significantly more helium.

FIG. 8 shows a graph of the partial pressure of the nitrogen comprising the initial gas content of the optical fibre inside the fibre (vertical axis) along the length of the fibre (horizontal axis), over time, obtained from the modelling. At time 0 (line g) the nitrogen fills the hollow core of the fibre and has its initial and maximum partial pressure, constant along the whole fibre length; as noted above this is the time at which the helium purge gas has just permeated through the side wall and is about to start moving into the hollow core of the fibre to displace the nitrogen and push it out of the fibre ends. The nitrogen partial pressure is shown at later times of 1000, 5000, 10000, 20000, 50000 and 100000 seconds, as lines h, l, j, k, l and m respectively. Line m shows the partial pressure of the nitrogen as having been reduced virtually to zero, such that the nitrogen can be considered to have been almost entirely evacuated from the optical fibre, so that the purge is complete (for a scenario in which substantially complete removal of the nitrogen is the aim, such that the threshold marking the end of purge time is very low (1% or less, for example). The modelled purge time for this 500 m length of fibre to reduce to 1% nitrogen content in the fibre is 22.3 hours. This timescale indicates that the proposed approach of side indiffusion of purge gas can compare favourably with current fibre end-based access for purging and evacuation.

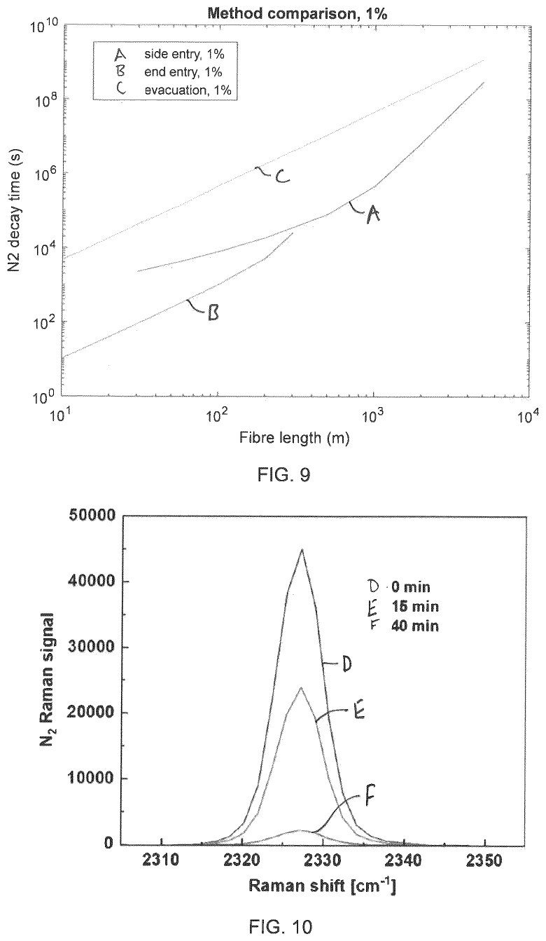

FIG. 9 illustrates a comparison, and shows a graph obtained by modelling of the nitrogen decay time (in seconds, vertical axis) taken to reduce the partial pressure of nitrogen in the hollow core of a fibre to 1% of the initial partial pressure (100 kPa to 1 kPa (1 bar to 10 mbar)) for fibres lengths from 10 m to 5 km (horizontal axis), for different methods. The modelled optical fibre is made of silica and the purge gas is helium. Line A shows side permeation of helium as proposed herein. Line B shows helium permeation via a fibre end (the helium enters at one end and pushes the nitrogen out of the other end) according to known methods. Line C shows evacuation via the fibre ends (the nitrogen is vacuum pumped out of a fibre at both ends). For the 500 m length of fibre modelled in FIGS. 7 and 8, the side permeation method proposed herein achieves 1% partial pressure of nitrogen in 22.3 hours, whereas vacuum pumping to evacuate the fibre takes the much longer time of 132 days to achieve 1% partial pressure. The known end purging method (also using 2000 kPa helium purge gas pressure) does not work at all on this length of fibre, and indeed only works for fibres shorter than 300 m. This is because the helium pushed in at one end of the fibre permeates out through the fibre side wall before it is able to reach the far end of the fibre, and hence fails to purge the nitrogen. In contrast, the side permeation approach, while slower for short fibre lengths, is able to purge fibres up to 5000 m (maximum length modelled).

FIG. 10 shows experimental results obtained for side purging of a silica hollow core optical fibre with an initial gas content of air at atmospheric pressure (100 kPa, 1 bar), and helium as the purge gas, at a purge gas pressure of 2000 kPa (20 bar). The fibre had a central portion length of 1.56 m in the pressure vessel, with end portion lengths outside the pressure vessel of 0.72 m (where some outward permeation of helium through the side wall also occurs). The hollow core/cladding diameter was 46 μm, and the outer jacket/side wall thickness was 69 μm. The graph shows detected Raman backscattered light of 532 nm laser light scattered from the nitrogen in the fibre core (as the Raman shift frequency, vertical axis). The Raman signal, proportional the remaining amount of nitrogen in the fibre core, is shown for time of 0 minutes (line D), 15 minutes (line E) and 40 minutes (line F). At 40 minutes the Raman signal shows that the nitrogen has been almost completely removed from the fibre.

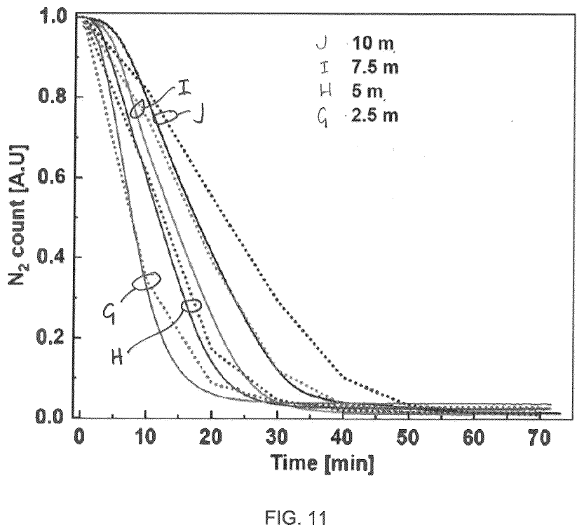

FIG. 11 shows a graph of further experimental results, compared with modelling. The nitrogen amount or count is shown in arbitrary units on the vertical axis, while the horizontal axis shows time. Fibre lengths of 2.5 m (lines G), 5 m (lines H), 7.5 m (lines I) and 10 m (lines J) are shown (solid lines for experimental measurements, dotted lines for modelling). The results indicate times of the order of tens of minutes for the helium purge gas to replace the nitrogen, with longer fibres taking longer to be filled with helium. The modelling overestimated purge times by about 25-30%. Note the non-zero nitrogen count in the steady state reached at the long time periods; this is due to indiffusion of nitrogen from the surrounding air at the open fibre ends, as mentioned above. This effect is more dominant for shorter fibre lengths, in which the unpressurised end portions make up a large proportion of the total fibre length.

In general, any non-zero pressure differential (the pressure difference between the gas purge pressure and the pressure of the purge gas within the initial gas content in the optical fibre) could be used, since the pressure gradient will drive the inward permeation of the purge gas through the side wall of the fibre. However, larger pressure differentials and higher purge pressures accelerate the permeation rate, and reduce the purge time required to achieve the desired remaining fraction of the initial gas content. Also, some purge gases require higher pressures than others to achieve a permeation rate that gives a usefully short purge time. Pressures for a selection of purge gases are given below. Another consideration when selecting an appropriate purge gas pressure is the maximum pressure which the thin walled capillaries forming the cladding of the optical fibre are able to withstand. There is no point in using a very high gas purge pressure to drive the purge gas more quickly through the fibre side wall, if the pressure is so high that it damages the internal structure of the fibre once the purge gas reaches the interior of the fibre. Experimental reports indicate that hollow core optical fibres can generally withstand internal pressures around 10000 kPa (100 bar) or 15000 kPa (150 bar) so this might be considered as a useful indicator of a practical upper limit for the purge gas pressure. On the other hand, in order to benefit from the shortened process times enabled by the proposed process, the purge gas pressure should preferably not be too low. For example, a purge gas pressure might usefully be at least 2000 kPa (20 bar), as in the modelling and experiments described above. Accordingly, in some examples, the purge gas pressure is 2000 kPa or higher. In some examples, the purge gas pressure is 10000 kPa or lower, or 15000 kPa or lower. In some examples, the purge gas pressure is in the range of 2000 kPa to 15000 kPa. Purge gas pressures outside these ranges are not excluded, however. As discussed above, the permeation rate and the purge time depend on many combining and competing factors, so that in some cases a lower purge gas pressure may still allow sufficient permeation for an acceptable purge time, while in other cases, a particular fibre structure may be able to withstand pressure higher than 15000 kPa so that a higher purge gas pressure can be used to further reduce the purge time. In terms of the total pressure differential, since as noted above the pressure of the gas content in a newly fabricated fibre may be as low as 25 kPa (0.25 bar), the pressure difference between the purge gas pressure and the initial gas content pressure in the fibre might be defined being up to about 14975 kPa, or in the range of about 1975 kPa to 14975 kPa.

The purge gas pressure may be maintained constant during the purge time, as in the modelling and experiments described above. In other examples, the gas purge pressure might be varied during the purge time. For example, the gas purge pressure might be increased (ramped up) during an initial section of the purge time, such as from atmospheric pressure to a maximum required gas purge pressure. The gas purge pressure might be decreased (ramped down) during a final section of the purge time, such as from the maximum utilised gas purge pressure to atmospheric pressure. A steady state period in which the purge gas pressure is maintained constant at the maximum pressure might be interposed between the initial ramp up period and the final ramp down period.

As noted above, helium is considered a particularly useful purge gas since it is capable of permeating through silica at room temperature. Hence, a process using helium can be run with the purge gas at about 20° C. throughout the purge time, thereby avoiding any need to heat the purge gas or the fibre. However, raising the temperature of the purge gas (as a simple way to also raise the temperature of the fibre material) will increase the permeation rate, so if a shorter purge time is desired, the process may be run with helium heated above 20° C. Other purge gases may operate less well at room temperature, so that heating will be appropriate to achieve reasonable purging. Any desire to increase the permeation rate by using high temperatures will need to be balanced against the ability of any particular optical fibre to tolerate heat. Often, optical fibres are provided with a protective polymer coating during fabrication. Standard or typical polymer coatings are expected to tolerate temperatures up to about 150° C., so in some cases this places an upper limit on the maximum temperature to which the purge gas should be heated. More specialist high temperature coatings are available, however, so if such a coating is present on the optical fibre a purge gas temperature above 150° C. can be used, for example up to 250° C. or up to 500° C. or up to 750° C. In other cases, the optical fibre may be uncoated, so that coating-based temperature limitations are removed, and purge gas temperatures up to about 1000° C. might be used.

Examples of other gases which are known to be capable of permeating or diffusing through materials from which optical fibres are made such as glass and polymers include hydrogen, neon and deuterium. While lacking the room temperature low pressure permeation capability of helium, these gases can be successfully used at high temperatures, and may be preferred in some cases. Also, high pressures can overcome or reduce the need for heating in some cases. For example, a hollow core optical fibre filled with one of these gases may be specifically required for some applications. In other cases, it may be desired to maintain a higher internal pressure or avoid a vacuum. Sealing the fibre ends after purging will retain a non-helium purge gas within the fibre under normal conditions, since unlike helium the purge gas will not permeate out through the side wall at room temperature. Combinations of higher pressures and lower (or room) temperatures, or lower pressures and higher temperatures might be used for these gases

Table 1 gives some example parameter ranges under which these example purge gases may be used. Use of these gases at other temperatures and pressures is not excluded, however. Similarly, other gases might be used if they can permeate through a material from which a particular fibre is fabricated. For higher temperatures in the stated ranges, such as temperatures above 150° C., the fibre material can usefully be silica, since some glasses and polymers are not able to well tolerate higher temperatures.

TABLE 1

| | Example purge gas | |
|---|---|---|
| Purge gas | pressure range | Example purge gas temperature range |
| Helium | 100 kPa to 15000 kPa | 20° C. to 150° C. for optical fiber with standard |
| | (1 bar to 150 bar) | protective polymer coating. |
| | | 20° C. to 500° C. for optical fibre with high temperature |
| | | protective polymer coating. |
| | | 20° C. to 1000° C. for uncoated optical fibre. |
| Hydrogen | 5000 kPa to 15000 kPa | 20° C. to 150° C. for optical fiber with standard |
| | (50 bar to 150 bar) | protective polymer coating. |
| | | 20° C. to 500° C. for optical fibre with high temperature |
| | | protective polymer coating. |
| | | 20° C. to 1000° C. for uncoated optical fibre. |
| Neon | 10000 kPa to 15000 kPa | 20° C. to 150° C. for optical fiber with standard |
| | (100 bar to 150 bar) | protective polymer coating. |
| | | 20° C. to 500° C. for optical fibre with high temperature |
| | | protective polymer coating. |
| | | 20° C. to 1000° C. for uncoated optical fibre. |
| Deuterium | 5000 kPa to 15000 kPa | 20° C. to 150° C. for optical fiber with standard |
| | (50 bar to 150 bar) | protective polymer coating. |
| | | 20° C. to 500° C. for optical fibre with high temperature |
| | | protective polymer coating. |
| | | 20° C. to 1000° C. for uncoated optical fibre. |

Regarding the length of the optical fibre, this is defined herein as the total end to end length of the optical fibre, divided notionally into a central portion that receives the higher pressure purge gas via the side walls and the two end portions that remain outside the pressure vessel during processing. For shorter fibres, the purge time can be reduced if the central portion is maximised, since a larger proportion of the total surface area of the fibre is available for ingress of the purge gas. For long fibres, the central portion length can be chosen to maximise the pressure gradient along the length of the fibre for efficiently pushing out the initial gas content. Usefully, therefore, in some examples, the central portion of the optical fibre comprises at least 60% of the total length of the fibre (for example for a 1 km fibre length with 200 m length end portions, at 2000 kPa purge gas pressure), and may extend up to near 100% (at least 99%, for example) where it is convenient to minimise the length of the end portions. This may be limited by the amount of fibre needed to pass through the pressure sealed fibre outlets in the pressure vessel, and a need to access the fibre ends for monitoring, sealing or other purposes. Also, it is useful to minimise the length of the end portions to reduce outward permeation of the purge gas through the side walls at the end portions during the purge, to minimise the smallest achievable remaining fraction of the initial gas content and reduce the purge time. However, in other examples, a central portion which is shorter than 60% of the total fibre length may be acceptable or indeed useful. Longer fibre ends may be better tolerated for longer total fibre lengths, where they can make up proportionally less of the total fibre. Loss of the purge gas through the side walls depends on many factors, as for the inward permeation inside the pressure vessel, so may be more or less of a problem in different configurations. The length of the end portions can be selected with this in mind, plus the above noted practical aspects of the fibre outlets and any required access to the fibre ends. Purely as examples, therefore, the end portions may each have a length of 1 m or less for fibres with a total length of 100 m or less, or 200 m or less for fibres with a total length of 1 km or less. Longer end portion lengths are not excluded, however, and the two end portions need not be the same length.

In a further example, the end portions might be wholly or partly removed from the optical fibre after purging, by cleaving the fibre, with the new end facets being sealed or not sealed as required. Residual initial gas content that has not been fully pushed out of the fibre, or gas content which has diffused into through the end facets, can thereby be removed.

The proposed method has been shown to be more effective, versatile and/or efficient that existing evacuation methods, both in terms of speed (reduced total process time) and the ability to process longer lengths of optical fibre. In some examples, therefore, the optical fibre has a total length in the range of 30 m to 5 km, or in the range of 30 m to 100 m for shorter fibres, or in the range of 300 m to 2 km or 300 m to 5 km for longer fibres. Longer and shorter fibres outside these ranges are not excluded, however.

It will be appreciated that owing to the interplay of many factors that contribute to the permeation rate, for any particular fibre (regarding length and side wall thickness), choice of purge gas, temperature and pressure, the purge time to achieve the desired reduction in the internal gas content can vary widely. For example, the purge time may be in the range of 10 seconds to 1 month, but this is not limiting.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in the future.

### REFERENCES

[1] U.S. Pat. No. 9,904,008
[2] WO 2015/185761
[3] S E Barkou et al, “Photonic bandgap fibers”, LEOS '99, IEEE Lasers and Electro-Optics Society 1999 12th Annual Meeting, vol. 2 IEEE, 1999
[4] J Broeng et al, “Analysis of air-guiding photonic bandgap fibers”, Optics Letters vol. 25(2), 96-98, 2000
[5] Francesco Poletti, “Nested antiresonant nodeless hollow core fiber,” Opt. Express, vol. 22, 23807-23828, 2014
[6] JR Hayes et al, “Antiresonant hollow core fiber with an octave spanning bandwidth for short haul data communications”, Journal of Lightwave Technology vol. 35(3), 437-442, 2017
[7] US 2011/097045
[8] P S Light et al, “Low optical insertion-loss and vacuum-pressure all-fiber acetylene cell based on hollow-core photonic crystal fiber,” Optics Letters vol. 31, 2538-2540, 2006.

1. A method for processing a hollow core optical fibre fabricated from a material, having a side wall surrounding a cladding and a hollow core, and having a central portion and two end portions, the method comprising:
placing the central portion of the optical fibre into the interior of a pressure vessel;
arranging both end portions of the optical fibre outside of the pressure vessel via pressure sealed apertures;
adding a purge gas to the interior of the pressure vessel, the purge gas being a gas species capable of permeating through the material, wherein the purge gas has a purge gas pressure greater than a partial pressure of the purge gas species within an initial gas content of the cladding and the hollow core of the optical fibre;
during a purge time, allowing the purge gas at the purge gas pressure to permeate into the optical fibre through a side wall of the central portion of the fibre to enter the cladding and the hollow core and push the initial gas content towards ends of the optical fibre and out of the cladding and the hollow core via the ends; and
ending the purge time when a fraction of the initial gas content in the cladding and the hollow core falls below a predefined threshold.

2. A method according to claim 1, wherein the predefined threshold is in the range of 0.1% to 10% of the initial gas content.

3. A method according to claim 1, wherein the purge gas pressure is in the range of 100 kPa to 15000 kPa.

4. A method according to claim 1, wherein a pressure difference between the purge gas pressure and the partial pressure of the purge gas species within the initial gas content is in the range of 100 kPa to 15000 kPa.

5. A method according to claim 1, comprising varying the purge gas pressure during the purge time.

6. A method according to claim 5, comprising increasing the purge gas pressure during an initial section of the purge time, and decreasing the purge gas pressure during a final section of the purge time.

7. A method according to claim 1, wherein the material is a glass.

8. A method according to claim 6, wherein the material is a synthetic silica.

9. A method according to claim 1, wherein the purge gas is helium.

10. A method according to claim 9, wherein, during the purge time, the purge gas has a temperature of substantially 20° C.

11. A method according to claim 9, further comprising: after the purge time, sealing the ends of the optical fibre, and allowing the helium to permeate out of the optical fibre through the side wall to achieve a reduced pressure or a vacuum in the cladding and the hollow core.

12. A method according to claim 11, further comprising heating the optical fibre to increase a rate at which the helium permeates out of the optical fibre.

13. A method according to claim 1, wherein during the purge time, the purge gas has a temperature above 20° C.

14. A method according to claim 1, wherein:
the purge gas is helium; and
the purge gas pressure is in the range of 100 kPa to 15000 kPa.

15. A method according to claim 1, wherein:
the purge gas is hydrogen; and
the purge gas pressure is in the range of 5000 kPa to 15000 kPa.

16. A method according to claim 1, wherein:
the purge gas is neon; and
the purge gas pressure is in the range of 10000 kPa to 15000 kPa.

17. A method according to claim 1, wherein:
the purge gas is deuterium; and
the purge gas pressure is in the range of 5000 kPa to 15000 kPa.

18. A method according to claim 14, wherein:
the optical fibre has a protective polymer coating; and
during the purge time, the purge gas has a temperature in the range of 20° C. to 150° C.

19. A method according to claim 14, wherein:
the material is silica;
the optical fibre has a high temperature protective polymer coating; and
during the purge time, the purge gas has a temperature in the range of 20° C. to 500° C.

20. A method according to claim 14, wherein:
the material is silica;
the optical fibre lacks a protective polymer coating; and
during the purge time, the purge gas has a temperature in the range of 20° C. to 1000° C.

21. A method according to claim 1, wherein the central portion of the optical fibre comprises at least 60% of a total length of the optical fibre.

22. A method according to claim 1, wherein the end portions of the optical fibre each have a length of 200 m or less.

23. A method according to claim 1, wherein the optical fibre has a total length in the range of 30 m to 5000 m.

24. A method according to claim 1, wherein the purge time has a duration in the range of 10 seconds to 1 month.

25. A method according to claim 1, wherein a pressure of the initial gas content is less than 100 kPa, and the predefined threshold is set such that the purge time is ended when a pressure of the gas content of the cladding and the hollow core is substantially 100 kPa.
